(19) United States
(12) Patent Application Publication
(10) Pub. No.: US 2026/0023512 A1
(43) Pub. Date: Jan. 22, 2026

(54) MONITORING PRINTER STATUS USING OPERATING SYSTEM WITH DRIVERLESS PRINTING FUNCTION

(71) Applicant: BROTHER KOGYO KABUSHIKI KAISHA, Nagoya (JP)

(72) Inventor: Masatoshi KADOTA, Takahama (JP)

(21) Appl. No.: 19/341,158

(22) Filed: Sep. 26, 2025

Related U.S. Application Data
(63) Continuation of application No. PCT/JP2024/010209, filed on Mar. 15, 2024.
(63) Continuation of application No. PCT/JP2024/010210, filed on Mar. 15, 2024.

(30) Foreign Application Priority Data
Mar. 30, 2023 (JP) 2023-055831
Mar. 30, 2023 (JP) 2023-055832

(51) Int. Cl. G06F 3/12

(52) U.S. Cl. CPC G06F 3/1228; G06F 3/1222; G06F 3/1231; G06F 3/1232; G06F 3/1296; G06F 3/1236

(57) ABSTRACT

A non-transitory computer-readable recording medium stores an information processing program executable by a processing unit of an information processing device that communicates with a corresponding printing device. The information processing device includes an operating system with an OS-standard printing software for driverless printing. The information processing program, when registered as a virtual printing device with the OS-standard printing software and executed, causes the information processing device to obtain first print data from the OS-standard printing software; transmit second print data based on the first print data to a printing device; output an inquiry signal to the printing device to query status of the printing device; and obtain status information from the printing device in response to the output of the inquiry signal.

### REFERENCE TO RELATED APPLICATIONS

This is a continuation application of International Application No. PCT/JP2024/010209 filed on Mar. 15, 2024, which claims priority from Japanese Patent Application No. 2023-055831 filed on Mar. 30, 2023, and of International Application No. PCT/JP2024/010210 filed on Mar. 15, 2024, which claims priority from Japanese Patent Application No. 2023-055832 filed on Mar. 30, 2023. The entire contents of the aforementioned applications are incorporated herein by reference.

### TECHNICAL FIELD

The present disclosure relates to monitoring printer status using an operating system with driverless printing function.

### BACKGROUND ART

An operating system (OS) equipped with driverless printing function, which allows printing without using a printer driver provided by a printer vendor in compliance with a particular printing standard, is becoming common. Thus, printing without installing a printer driver is available.

An information processing apparatus having a virtual printer function is known. Using the driverless OS printing function, the virtual printer receives a print job from the OS and transmits the print job to a printer. This configuration is to support printers that do not support driverless printing or to extend functionality of standard driverless printing.

A status monitor device is also known. The device notifies a user of status of printers and print queues, and consumption status of consumables. Such status monitor device has been a standalone module, separate from printer drivers and the aforementioned virtual printers.

### SUMMARY

In an environment performing the driverless OS printing function, depending on the type of OS and connection method between the information processing device and the printer, it may occur that only a standalone application can obtain access to a backend for communication with the printing device. Even if the access is obtained, communication for executing printing may restrict communication for status monitoring, or vice versa. Furthermore, the printing device must handle both communication for printing and communication for status monitoring simultaneously, which may be burdensome.

Moreover, when a new printer is connected to the network, it is desirable to quickly obtain status information such as ink levels.

An aspect of the present disclosure is to enable stable coexistence of printing and status monitoring in an environment performing driverless OS printing functions.

A non-transitory computer-readable recording medium of the present disclosure stores an information processing program executable by a processing unit of an information processing device that communicates with a corresponding printing device. The information processing device includes an operating system with an OS-standard printing software for driverless printing. The information processing program, when registered as a virtual printing device with the OS-standard printing software and executed, causes the information processing device to obtain first print data from the OS-standard printing software; transmit second print data based on the first print data to a printing device; output an inquiry signal to the printing device to query status of the printing device; and obtain status information from the printing device in response to the output of the inquiry signal.

According to the present disclosure, the virtual printing device registered with the OS-standard printing software queries the status of the printing device and obtains status information. Since the virtual printing device intermediates both printing and status monitoring between the OS-standard printing software and the printing device, communication for printing and communication for status monitoring do not interfere with each other. Thus, stable coexistence of printing operations and status monitoring are enabled.

Furthermore, even when a new printer is connected to the network, the system easily and efficiently manages printer consumables.

### BRIEF DESCRIPTION OF DRAWINGS

FIG. 1 is a diagram illustrating an example of the overall configuration of a printing system according to an embodiment.

FIG. 2 is a flowchart illustrating an example of processing steps related to status monitor executed by a printer application of a first or second client PC.

FIG. 3 is a flowchart illustrating an example of control steps for adding or removing printer.

FIG. 4 is a flowchart illustrating an example of control steps for periodic processing and data collection commands from management software.

FIG. 5 is a flowchart illustrating an example of control steps for status collection commands from management software.

FIG. 6 is a flowchart illustrating an example of control steps for Pause/Resume button notifications from a management PC.

FIG. 7 is a flowchart illustrating an example of control steps for cleaning button operations from a management PC.

FIG. 8 is a diagram illustrating an example of status information aggregation methods by a management aggregation unit of a management PC.

FIG. 9 is a diagram illustrating an example of a management software screen.

FIG. 10 is a diagram illustrating an example of access occupation to a backend when no printer application is present.

FIG. 11 is a diagram illustrating an example of access occupation to a backend when a printer application is present.

FIG. 12 is a flowchart illustrating an example of processing steps for obtaining access privilege by a printer application.

FIG. 13 is a flowchart illustrating an example of processing steps related to status monitoring by management software of a management PC.

FIG. 14 is a block diagram illustrating an example of hardware configuration of a client PC and a printer.

FIG. 15 is a block diagram illustrating an example of hardware configuration of a management PC.

### DESCRIPTION

Examples of embodiments of the present invention will be described with reference to the drawings.

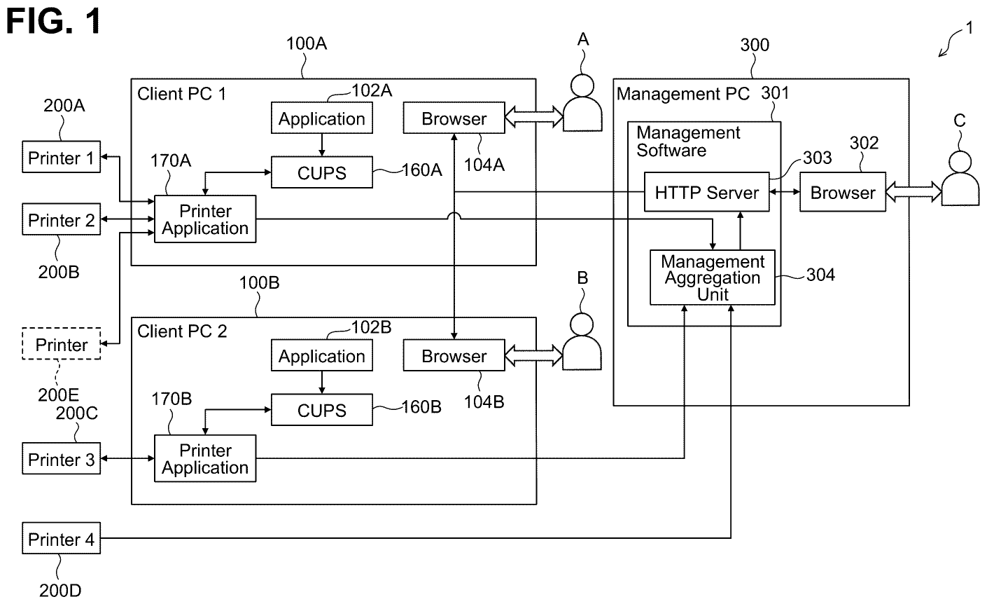

FIG. 1 illustrates an example of the overall configuration of a printing system 1 according to an embodiment. As shown in FIG. 1, the printing system 1 includes a plurality of client PCs 100A, 100B, a plurality of printers 200A-200D, and a management PC 300. The first client PC 100A is a terminal device used by user A and is communicably connected to the first printer 200A and the second printer 200B via USB (Universal Serial Bus) cables. The second client PC 100B is a terminal device used by user B and is communicably connected to the third printer 200C via a USB cable. The management PC 300 is a terminal device used by administrator C of the printing system 1 and is communicably connected to the first client PC 100A and the second client PC 100B via a network such as the Internet, wired LAN, or wireless LAN. The fourth printer 200D is also communicably connected to the management PC 300 via a network such as the Internet, wired LAN, or wireless LAN.

The printing system 1 is an example of an information processing system. The first and second client PCs 100A, 100B are examples of information processing apparatuses and first information processing apparatuses. The printers 200 are examples of printing apparatuses. The management PC 300 is an example of an external device and a second information processing apparatus.

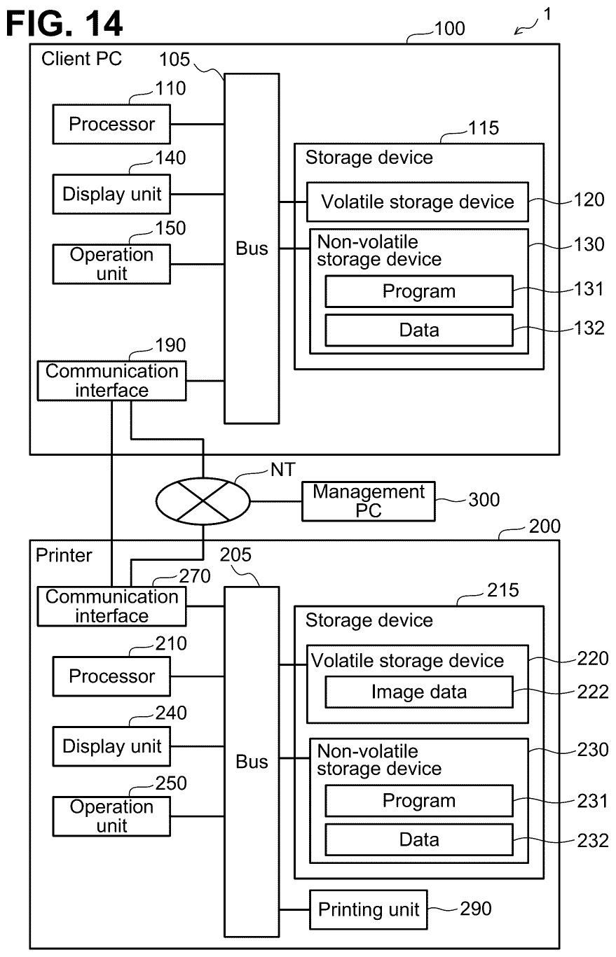

The first client PC 100A transmits print data to the first printer 200A and the second printer 200B to execute printing. The first client PC 100A may be a desktop PC, a notebook PC, a tablet computer, or a mobile device such as a smartphone. As described later with reference to FIG. 14, the first client PC 100A includes a processor 110 and a storage device 115 that stores various information processing programs. By executing the various information processing programs, the processor 110 enables the first client PC 100A to have functional configurations shown in FIG. 1. The processor 110 is an example of a processing unit.

The first client PC 100A includes an operating system (OS) equipped with Common UNIX Printing System (CUPS) 160A. The first client PC 100A includes an editing application 102A, the CUPS 160A, a printer application 170A, and a browser 104A. The editing application 102A outputs print jobs to the CUPS 160A. The CUPS 160A is a modular printing system built into the OS that enables driverless printing without using vendor-specific printer drivers. The CUPS 160A is an example of an OS-standard printing software. The printer application 170A is an example of an information processing program.

The printer application 170A can be registered with the CUPS 160A as a virtual printer corresponding to the connected first printer 200A and the second printer 200B. The CUPS 160A handles the printer application 170A as a virtual printer and executes various processes related to printing. The various processes may include processing for obtaining capability information and processing for transmitting print data. In response to the processing for obtaining capability information of the CUPS 160A, the printer application 170A obtains attributes representing capabilities of the printers 200A, 200B, converts the obtained attributes based on whether the CUPS 160A can handle the attributes or whether there are functional restrictions, and outputs the converted attributes to the CUPS 160A. In response to the processing for transmitting print data of the CUPS 160A, the printer application 170A receives print data from the CUPS 160A. The print data corresponds to the attributes outputted by the processing for obtaining capability information of the CUPS 160A. The printer application 170A converts the received print data according to the attributes and functional restrictions of the printers 200A, 200B, and then transmits the converted print data to the printers 200A, 200B. The attribute before conversion is an example of first capability information. The attribute after conversion is an example of second capability information. The print data before conversion is an example of first print data. The print data after conversion is an example of second print data.

Additionally, the printer application 170A queries status of the first printer 200A and the second printer 200B, obtains status information from the first printer 200A and the second printer 200B, and performs processing to send the status information to the management PC 300. The details of this processing will be described later.

The browser 104A retrieves various information from an HTTP (Hypertext Transfer Protocol) server 303 of the management PC 300 and provides the retrieved information to user A. The various information includes status information of the printers 200A-200D.

The second client PC 100B transmits print data to the third printer 200C to execute printing. The second client PC 100B may be a desktop PC, a notebook PC, a tablet computer, or even a mobile device such as a smartphone. Similar to the first client PC 100A, the second client PC 100B has a processor 110 and a storage device 115 that stores various information processing programs, as described later with reference to FIG. 14. By executing the various information processing programs, the processor 110 enables the second client PC 100B to have functional configuration shown in FIG. 1.

The second client PC 100B includes an operating system (OS) equipped with CUPS 160B. The second client PC 100B includes an editing application 102B, the CUPS 160B, a printer application 170B, and a browser 104B. The CUPS 160B is also an example of an OS-standard printing software, and the printer application 170B is an example of an information processing program. These functions are similar to those of the first client PC 100A and will not be described.

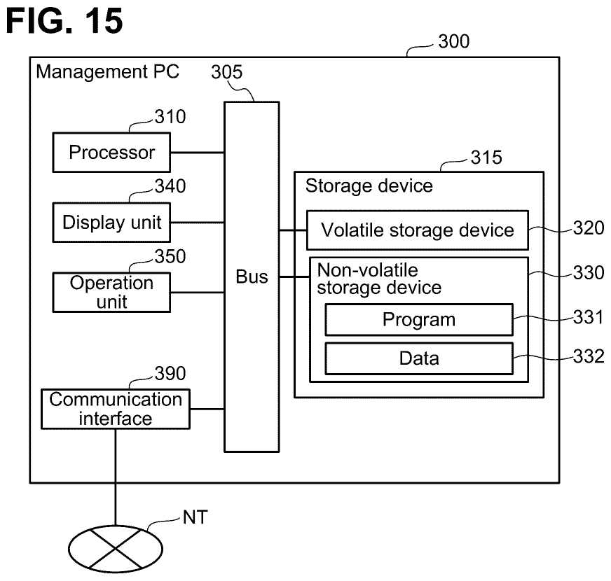

The management PC 300 may be a desktop PC, a notebook PC, or a tablet computer. As described later with reference to FIG. 15, the management PC 300 includes a processor 310 and a storage device 315 that stores various information processing programs. By executing the various information processing programs, the processor 310 enables the management PC 300 to have functional configuration shown in FIG. 1. The processor 310 is an example of a computing unit.

The management PC 300 includes management software 301 and a browser 302. The management software 301 is a program that manages the status information of each printer 200A-200D. The management software 301 includes an HTTP server 303 and a management aggregation unit 304. The management aggregation unit 304 receives and aggregates status information for the first printer 200A and the second printer 200B from the printer application 170A of the first client PC 100A. The management aggregation unit 304 receives and aggregates status information for the third printer 200C from the printer application 170B of the second client PC 100B. The management aggregation unit 304 receives and aggregates status information from the fourth printer 200D. The management aggregation unit 304 outputs the aggregated status information to the HTTP server 303. The HTTP server 303 is server software that operates on the management software 301. The HTTP server 303 receives status information from the management aggregation unit 304 and provides the status information to administrator C via the browser 302, as well as to users A and B via the browsers 104A, 104B. The management software 301 is an example of an information processing program.

In this embodiment, when distinguishing between the first client PC 100A and the second client PC 100B is unnecessary, they may collectively be referred to as “client PC 100.” Similarly, the CUPS 160A, 160B may be referred to as “CUPS 160.” The printer applications 170A, 170B may be referred to as “printer application 170.” The printers 200A-200D may be referred to as “printer 200.”

Furthermore, system configuration of the printing system 1 described above is just an example and may not be limited to the above-described configuration. For instance, the number of the client PC 100 may not be limited to two but can be three or more, or even one. The management PC 300 may be more than one device. The printers 200 in the printing system 1 may be more than four or even just one. One printer 200 may be connected to the printer application 170 while multiple printers 200 may be connected to the printer application 170. The printers 200 may be connected to the management PC 300 via a network without via the client PCs 100. The connection between the client PCs 100 and the printers 200 may not be via the USB; it may also be via a network such as the Internet, wired LAN, or wireless LAN.

### <Processing Related to Status Monitoring by Printer Application>

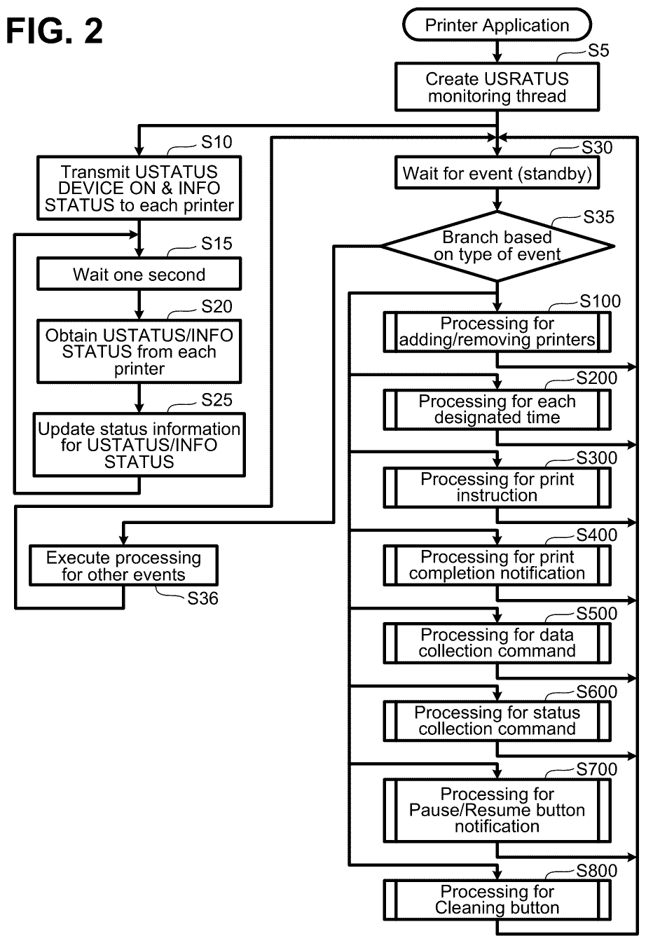

The processing steps related to status monitoring executed by the printer application 170 will be explained with reference to flowcharts in FIGS. 2 to 7. The printer application 170 executes the following flowchart when registered as a virtual printer with the CUPS 160.

As shown in FIG. 2, in step S5, the printer application 170 creates a USTATUS monitoring thread. The USTATUS monitoring thread obtains status information from each printer via USTATUS. USTATUS is a command that requests the status information when a status changes in a monitoring event. Steps S10 to S25, which will be described later, are executed in the USTATUS monitoring thread created in step S5.

In step S10, the printer application 170 transmits PJL commands “USTATUS DEVICE ON” and “INFO STATUS” to each connected printer 200. PJL (Printer Job Language) is a job control language developed by Hewlett-Packard. “USTATUS DEVICE ON” is a command that enables transmission of status information via USTATUS. “INFO STATUS” is a command that requests current status information at the time of transmitting the command. These commands are examples of inquiry signals. Step S10 is an example of a processing for outputting an inquiry signal.

In step S15, the printer application 170 waits for a predetermined period, e.g., one second. The wait time may be other than one second.

In step S20, the printer application 170 receives status information from each connected printer 200 using USTATUS and INFO STATUS. The status information obtained via USTATUS is available when the status of printer 200 changes, while the status information obtained via INFO STATUS reflects the status at the time of transmitting the command. USTATUS status information is an example of status change data. Step S20 is an example of a processing for obtaining status information.

In step S25, the printer application 170 updates the status information stored in an appropriate storage area, such as a data storage area 132 of a non-volatile storage 130 in the storage device 115, with the status information obtained in step S20. Subsequently, the process returns to step S15.

By repeating steps S15 to S25, the printer application 170 executes steps S20 and S25 at predetermined intervals, e.g., every one second. This one-second interval is an example of a predetermined interval.

While repeating steps S15 to S25, the printer application 170 also executes processes starting from step S30 in parallel. In step S30, the printer application 170 waits until an event occurs. The event may be one of those described in steps S100 to S800.

In step S35, the printer application 170 determines the type of event. If the occurred event is not one of those described in steps S100 to S800 (step S35: No), the process proceeds to step S36, where the printer application 170 executes processing corresponding to other events. The process then returns to step S30. If the occurred event is one of those described in steps S100 to S800 (step S35: Yes), the printer application 170 executes the corresponding event process.

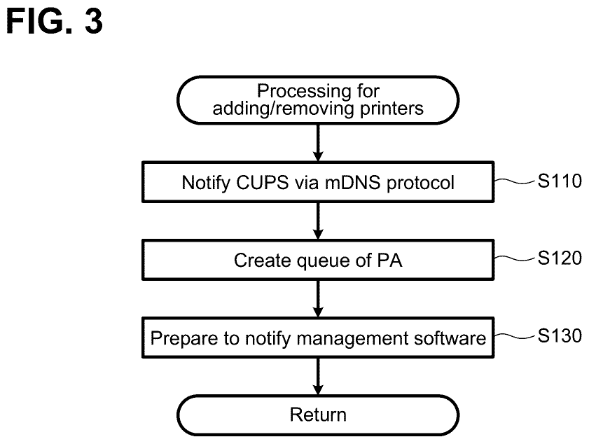

If the occurred event involves adding or removing a printer in the printing system 1, the printer application 170 executes processing in step S100. FIG. 3 illustrates an example of the details of step S100. This event occurs when the printer application 170 detects a newly connected printer via protocols such as mDNS or USB PnP information, or when a printer is added through user operation.

As shown in FIG. 3, in step S110, the printer application 170 notifies the CUPS 160 of the added printer 200E via the mDNS/SD (multicast Domain Name System/Service Discovery) protocol. Consequently, the CUPS 160 registers a virtual printer that is generated by the printer application 170 and corresponding to the printer 200E. The data necessary for this registration is provided by mDNS/SD. Thus, the CUPS 160 is communicable with the printer application 170, not with the printer 200E. Each virtual printer is identified by a uniform resource identifier (URI).

In step S120, the printer application 170 creates a print queue within itself. This print queue connects the virtual printer specified by the URI with the physical printer.

In step S130, the printer application 170 prepares to notify the printer 200 detected via mDNS in step S110 to the management software 301 of the management PC 300. When the management software 301 queries via mDNS/SD, information reflecting the addition or removal of the printer is returned. Then, the subroutine in FIG. 3 ends, and the process returns to step S30 in FIG. 2.

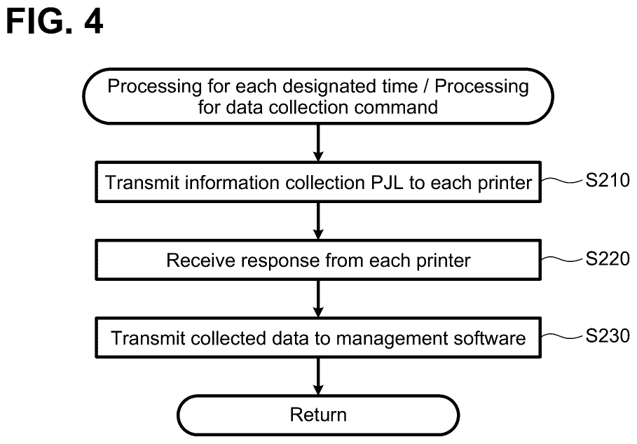

When the occurred event is arrival of a specified time, the printer application 170 executes processing for each specified time in step S200. When the occurred event is receipt of a data collection command from the management software 301, the printer application 170 executes processing for data collection command from management software in step S500. The processing contents of steps S200 and S500 are the same. FIG. 4 shows an example of the details of steps S200 and S500. When the event is the receipt of a data collection command from the management software 301, the printer application 170 accepts the data collection command from the management PC 300 in the YES judgment of step S35. The data collection command is an example of an information transmission request, and the YES judgment in step S35 is an example of an information request acceptance process.

As shown in FIG. 4, in step S210, the printer application 170 transmits information collection PJL to each connected printer 200. The information collection PJL is a command that requests transmission of consumable data related to the consumption status of consumables in each printer 200, such as toner levels and sheet levels. If the printer 200 is an inkjet printer, the consumable data may include ink levels. The information collection PJL is an example of a request for transmission, and step S210 is an example of processing for outputting request.

In step S220, the printer application 170 receives response information sent from each connected printer 200 in response to the information collection PJL, thereby obtaining consumable data for each printer 200. Step S220 is an example of processing for obtaining consumable data.

In step S230, the printer application 170 transmits the consumable data of each printer 200 obtained in step S220 to the management software 301 of the management PC 300 in response to the data collection command received in step S35. The subroutine of FIG. 4 then ends, and the process returns to step S30 in FIG. 2. Step S230 is an example of processing of outputting consumable information.

Steps S210 to S230 are executed at specified time intervals or upon receipt of a data collection command from the management PC 300. The specified time intervals may be predetermined specific times or predetermined intervals.

If the occurred event is a print instruction to the CUPS 160 or a print instruction to the printer 200 from the CUPS 160, the printer application 170 executes processing for print instruction in step S300. In step S300, the printer application 170 transmits a print start notification to the management software 301 of the management PC 300 and transmits print data to the corresponding printer 200 to execute printing.

If the occurred event is the completion of printing, the printer application 170 executes processing for print completion notification in step S400. In step S400, the printer application 170 transmits a print completion notification to the management software 301 of the management PC 300.

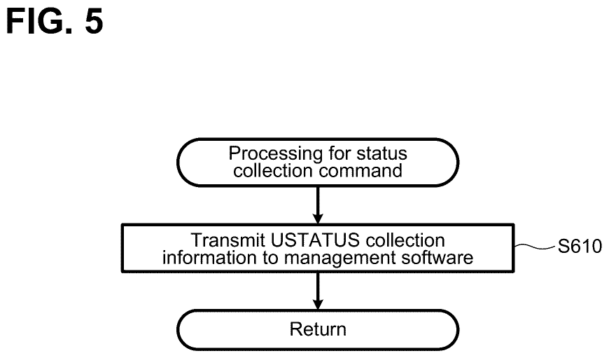

If the occurred event is triggered by the receipt of a status collection command from the management software 301, the printer application 170 executes processing for status collection command from management software in step S600. FIG. 5 illustrates an example of the details of step S600. The status collection command is an example of an information collection signal, and the YES determination in step S35 is an example of processing for obtaining information collection signal.

As shown in FIG. 5, in step S610, the printer application 170 aggregates status information in response to the status collection command and transmits the aggregated information to the management software 301 of the management PC 300. The aggregated status information includes the latest status information, via USTATUS and INFO STATUS, which is updated by repeating steps S15 to S25. The subroutine of FIG. 5 then ends, and the process returns to step S30 in FIG. 2. Step S610 is an example of processing for aggregating status information and processing for transmitting status information.

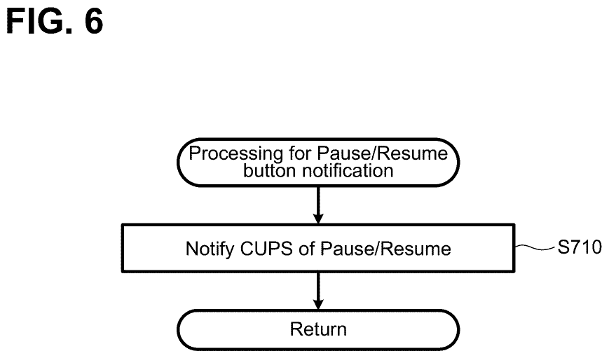

If the occurred event is a notification of Pause/Resume button from the management PC 300, the printer application 170 executes processing for Pause/Resume button notification from management PC in step S700. FIG. 6 illustrates an example of the details of step S700. The Pause button is operated by administrator C on the management software screen of the management PC 300 to temporarily halt printing on a specific printer 200, while the Resume button is operated to resume printing after a pause.

As shown in FIG. 6, in step S710, the printer application 170 instructs the CUPS 160 to pause or resume. Subsequently, the subroutine in FIG. 6 ends, and the process returns to step S30 in FIG. 2.

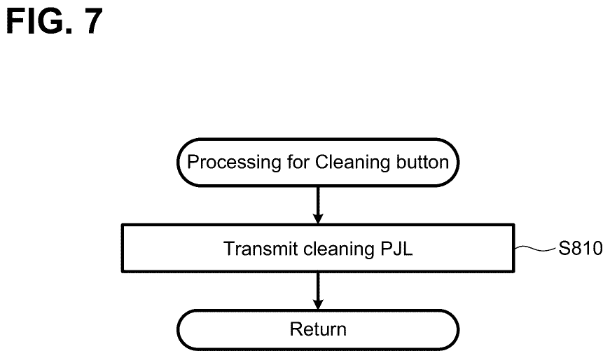

If the occurred event is a cleaning button notification from the management PC 300, the printer application 170 executes processing of step S800. FIG. 7 illustrates an example of the details of step S800.

As shown in FIG. 7, in step S810, the printer application 170 transmits a cleaning PJL command to the printer 200 corresponding to operation of the Cleaning button 308. The cleaning PJL is a command that requests toner cleaning for a laser printer. If the printer 200 is an inkjet printer, the command may request nozzle cleaning of the print head. The subroutine of FIG. 7 then ends, and the process returns to step S30 in FIG. 2.

Although not illustrated in the flowcharts of FIGS. 2 to 7, the printer application 170 outputs basic status information, which is part of the status information obtained in steps S10 to S25, to the CUPS 160. The basic status may include information on fundamental errors such as paper empty and paper jamming. This processing is an example of basic status output processing.

### <Aggregation of Status Information and Management Software Screen>

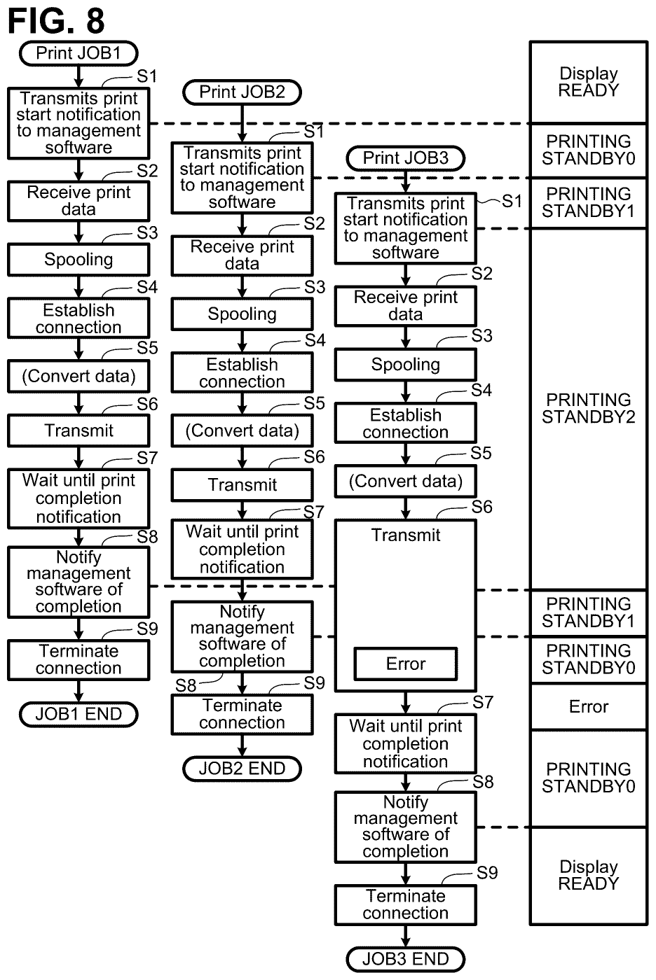

The management aggregation unit 304 of the management software 301 in the management PC 300 aggregates status information, for each printer, obtained from the printer applications 170A, 170B and the fourth printer 200D. FIG. 8 illustrates an example of a method of status information aggregation by the management aggregation unit 304. FIG. 8 describes the case where status information is obtained and aggregated from the printer application 170.

As shown in FIG. 8, the printer application 170 executes steps S1 to S9 for each print job. In step S1, the printer application 170 transmits a print start notification to the management software 301. In step S2, the printer application 170 receives the print data. In step S3, the printer application 170 spools the received print data. In step S4, the printer application 170 establishes a connection with the printer 200 that executes the print job. In step S5, the printer application 170 converts the print data based on the capabilities of the printer 200, according to any restrictions or extensions of printing functions. Step S5 may be skipped if the received print data is fully compatible with the printer 200, that is, there are no restrictions or extensions. In step S6, the printer application 170 transmits the converted print data, or the original print data if no conversion was needed, to the printer 200. In step S7, the printer application 170 waits until receiving a print completion notification from the printer 200. In step S8, the printer application 170 transmits a print completion notification to the management software 301. In step S9, the printer application 170 terminates the connection with the printer 200.

FIG. 8 exemplifies a scenario where the printer 200 receives three print jobs, i.e., Print Job 1, Print Job 2 and Print Job 3, at staggered intervals. The processing procedure for Print Job 2 is similar to that of Print Job 1, while Print Job 3 encounters a transmission error in step S6. During a period before step S1 for Print Job 1 begins, the status of the printer 200 is READY. Between executing step S1 for Print Job 1 and executing step S1 for Print Job 2, the status of printer 200 is PRINTING, with STANDBY=0. Here, the standby number, which is zero here, indicates the count of standby print jobs until the current print job completes and a print completion notification is received. Between executing step S1 for Print Job 2 and executing step S1 for Print Job 3, the status of the printer 200 is PRINTING, with STANDBY=1. Between executing step S1 for Print Job 3 and executing step S8 for Print Job 1, the status of the printer 200 is PRINTING, with STANDBY=2. Between executing step S8 for Print Job 1 and executing step S8 for Print Job 2, the status of the printer 200 is PRINTING, with STANDBY=1. Between executing step S8 for Print Job 2 and executing step S8 for Print Job 3, the status of the printer 200 is PRINTING, with STANDBY=0. If an error occurs during step S6 for Print Job 3, the status of the printer 200 changes to ERROR. After step S8 for Print Job 3 is executed, the status of the printer 200 returns to READY.

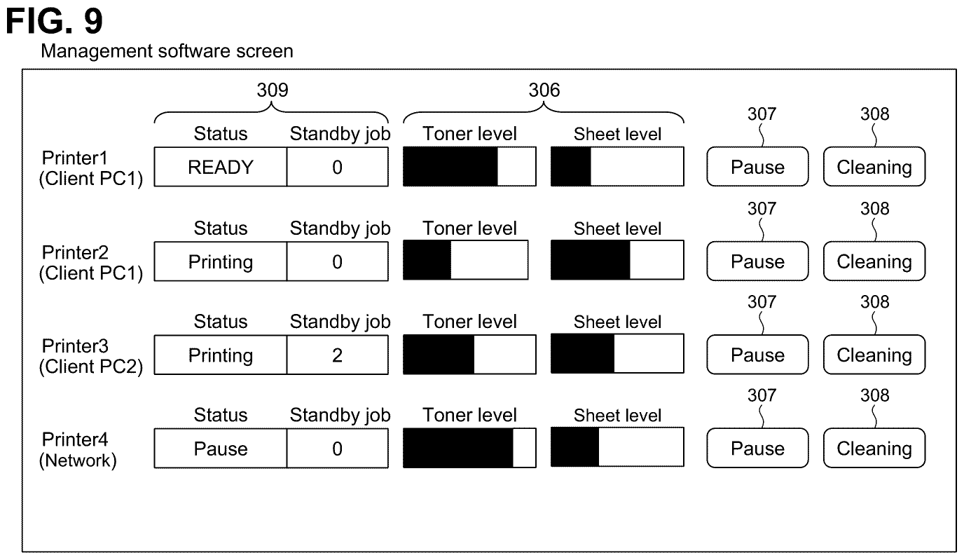

The management software 301 displays a list of aggregated status information for each of the printers 200A-200D on the display unit 340. FIG. 9 illustrates an example of the management software screen, i.e., status monitor screen, displayed by the management software 301.

As shown in FIG. 9, the management software screen displays the aggregated status information 309 and consumable data 306 related to the consumption status for the first printer 200A, the second printer 200B, the third printer 200C, and the fourth printer 200D. The status information 309 includes a status indicating READY or PRINTING, along with the number of standby print jobs. The consumable data 306 may include toner levels and sheet levels represented with gauges. Additionally, the management software screen displays a PAUSE/RESUME button 307 and a Cleaning button 308 for each printer. The PAUSE/RESUME button 307 toggles between PAUSE and RESUME each time the button is operated. The administrator C may operate the PAUSE/RESUME button 307 of any printer to pause printing on the corresponding printer 200. The administrator C may again operate the PAUSE/RESUME button 307 of the paused printer to resume printing on the paused printer. The administrator C may operate the Cleaning button 308 of any printer to execute toner cleaning on the corresponding printer 200.

The management software screen illustrated in FIG. 9 may also be displayed on the display units 140 of the first client PC 100A or the second client PC 100B.

In this embodiment, each client PC 100 obtains status information regarding local printers, e.g., the printer 200A and the printer 200B for the first client PC 100A, through the HTTP server 303 of the management PC 300. However, the printer application 170 may also include an internal HTTP server to obtain information about local printers. In such a case, the HTTP server publishes information stored in step S25 via the HTTP protocol, and the client PCs 100 can display status using their own local IP address, e.g., 127.0.0.1.

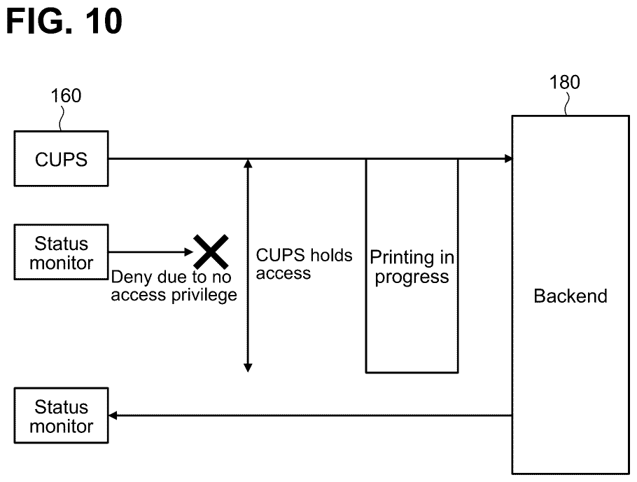

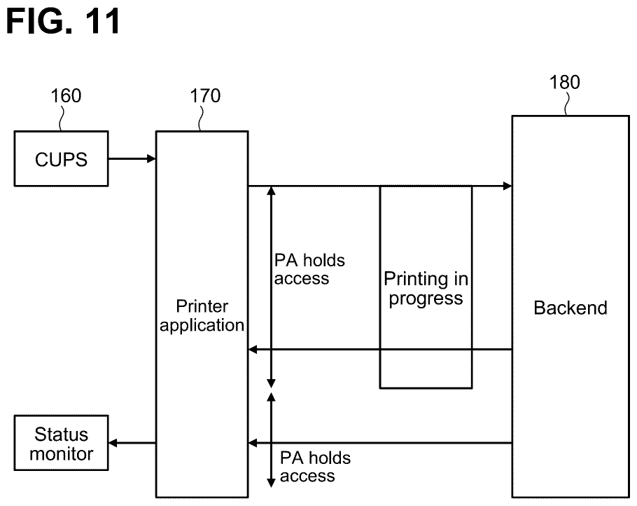

The HTTP server 303 of the management PC 300 may also perform authentication to restrict specific operations to administrator C only. While an example of first capability information is presented as an attribute, it may also be information, such as PPD, from a configuration file.

<Exclusive Access Privilege for Backend by Printer Application> In this embodiment, the printer application 170 exclusively holds access privilege to a backend 180 for communication with the printer 200 via a USB cable, and executes both print processing and status monitoring communication. This enables stable coexistence of print processing and status monitoring processing. FIGS. 10 and 11 illustrate the above configuration. The status monitor in FIGS. 10 and 11 refers to the processing necessary for status monitoring, corresponding to steps S10, S20 in FIG. 2 and steps S210, S220 in FIG. 4.

First, for comparison with this embodiment, FIG. 10 shows an example of access privilege to the backend 180 when the printer application 170 is absent. Access privilege is an example of right to use. When the client PC 100 is connected to the printer 200 via a USB cable and the OS with the CUPS 160 is Linux, only a single application can obtain access privilege to the backend 180 for communication with the printer 200. In this case, as shown in FIG. 10, when a status monitor accesses the backend 180 without via the printer application 170 while printing, the CUPS 160 occupies the access to the backend 180. Therefore, the status monitor cannot access the backend 180. Conversely, when printing is not in progress, the status monitor can access the backend 180. Thus, the configuration shown in FIG. 10 does not allow for the stable coexistence of print processing and status monitoring. Linux is a registered trademark of Linus Torvalds in the U.S. and other countries.

FIG. 11 illustrates an example of access privilege to the backend 180 in this embodiment. In this embodiment, as shown in FIG. 11, the printer application 170 mediates between the CUPS 160, the status monitor, and the backend 180 for both print processing and status monitoring processing. Thus, regardless of whether printing is in progress, the printer application 170 occupies access to the backend 180. Consequently, communication for print execution with the printer 200 and communication for status monitoring with the printer 200 do not interfere with each other. This allows for stable coexistence of print processing and status monitoring.

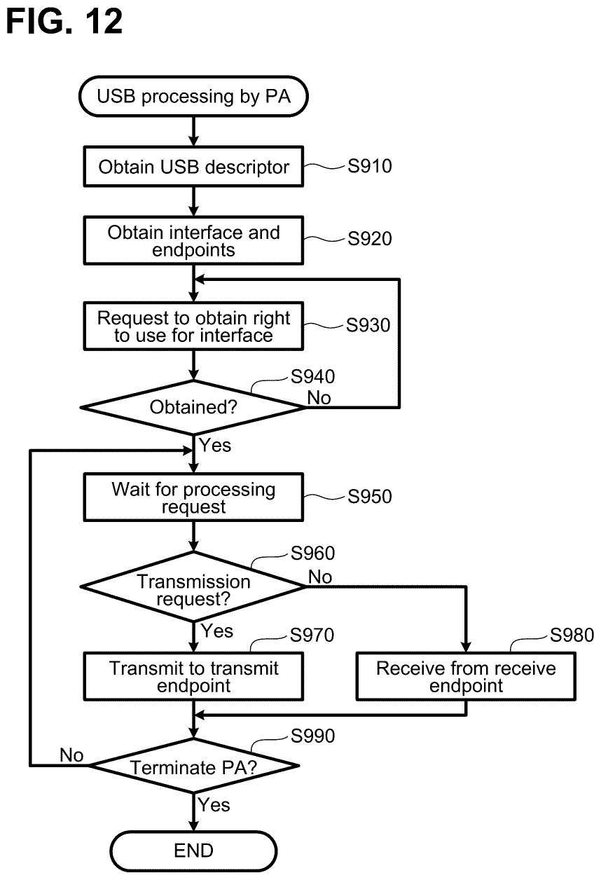

FIG. 12 illustrates an example of processing steps for obtaining access privilege by the printer application 170. In step S910, the printer application 170 obtains a USB descriptor. The USB descriptor is a data string that describes the specifications of the USB device.

In step S920, the printer application 170 obtains the interface, transmit endpoint, and receive endpoint described in the USB descriptor obtained in step S910.

In step S930, the printer application 170 requests the backend 180 to obtain right to use for the interface obtained in step S920.

In step S940, the printer application 170 determines whether the right to use for the interface have been successfully obtained. If the right to use cannot be obtained (step S940: No), the process returns to step S930. If the right to use are successfully obtained (step S940: Yes), the process proceeds to step S950. The YES determination in step S940 is an example of processing for obtaining access privilege.

In step S950, the printer application 170 waits until a processing request is received.

In step S960, the printer application 170 determines whether the received processing request is a transmission request. If the received request is a transmission request (step S960: Yes), the process proceeds to step S970.

In step S970, the printer application 170 transmits various types of data to the transmit endpoint obtained in step S920, based on the right to use obtained in step S940, via the backend 180. The data may include the USTATUS DEVICE ON and INFO STATUS commands transmitted in step S10, the information collection PJL transmitted in step S210, the cleaning PJL transmitted in step S810, and print data. The process then proceeds to step S990.

On the other hand, if the printer application 170 determines in step S960 that the received processing request is a reception request (step S960: No), the process proceeds to step S980.

In step S980, the printer application 170 receives various types of data from the receive endpoint obtained in step S920, based on the right to use obtained in step S940, via the backend 180. The data may include the status information via USTATUS and INFO STATUS obtained in step S20, and the responses obtained in step S220. The process then proceeds to step S990.

In step S990, the printer application 170 determines whether to terminate the process. If the process is not to be terminated (step S990: No), the process returns to step S950. If the process is to be terminated (step S990: Yes), the flow ends.

### <Processing Related to Status Monitoring by Management Software>

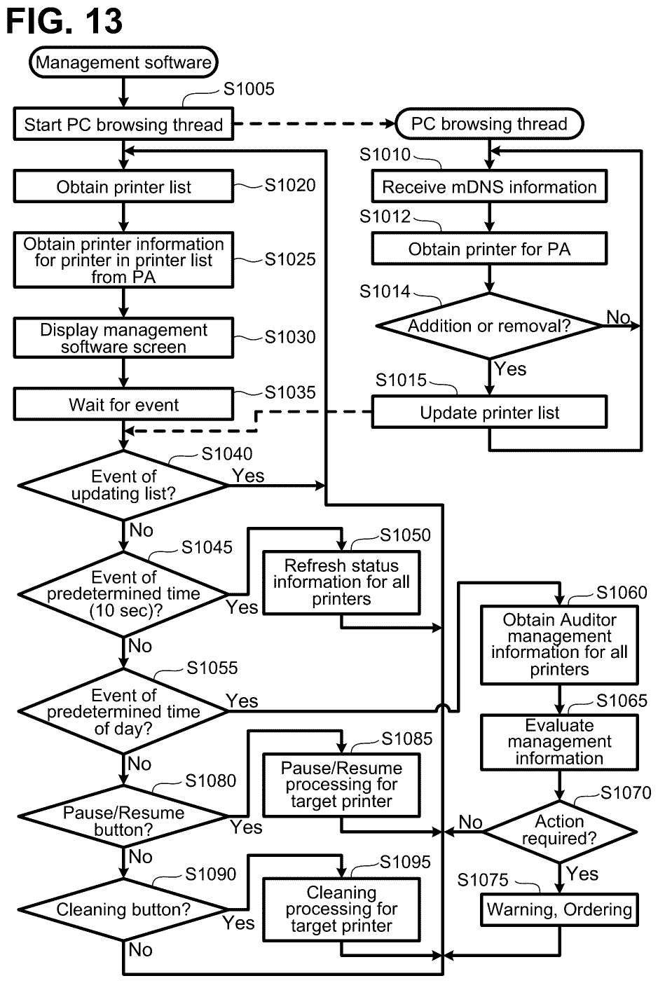

FIG. 13 illustrates an example of the processing steps related to status monitoring performed by the management software 301 of the management PC 300.

In step S1005, the management software 301 starts a PC browsing thread. The PC browsing thread is a thread for searching for the network printer 200D and virtual printers created by the printer application 170 in the printing system 1. The network printer 200D is searched via mDNS/SD protocol communication with the printer itself. The virtual printers corresponding to the printers 200A-200C are searched via mDNS/SD communication with the printer application 170.

In step S1010, the management software 301 searches for each printer application 170 on the client PCs 100 and obtains mDNS information from the printer applications 170. The mDNS information includes information of the printers 200 detected using mDNS by each printer application 170. Step S1010 is an example of a search process. This information reflects added or removed printers as updated in step S130.

The printer application 170 on the client PC 100 accepts search access executed by the management software 301 in step S1010. The processing performed by the printer application 170 is an example of processing for receiving search access.

In step S1012, the management software 301 obtains information about the printers 200 corresponding to each printer application 170 and the network printer 200D based on the mDNS information obtained in step S1010. For simplification, the processing related to the network printer 200D, which is not relevant to the present invention, is omitted from the explanation. However, in practice, the printer 200D is controlled in the same manner.

In step S1014, the management software 301 determines whether there has been any added or removed printers. If there is no addition or removal (step S1014: No), the process returns to step S1010. If there is an addition or removal (step S1014: Yes), the process proceeds to step S1015.

In step S1015, the management software 301 creates or updates a printer list based on the printer information obtained in step S1012. If the printer is a virtual printer, the list includes the virtual printer in association with information of the printer application 170 that created the virtual printer. Step S1015 is an example of processing for creating or updating a list. The process then returns to step S1010.

By repeating steps S1010-S1015, the management software 301 continuously updates the printer list of the printing system 1 to the latest state. In parallel with repeating steps S1010-S1015, the management software 301 also executes the processes from step S1020.

In step S1020, the management software 301 obtains the printer list corresponding to each printer application 170. This printer list is the one updated as needed in step S1015.

In step S1025, the management software 301 obtains printer information for each printer 200 included in the printer list obtained in step S1020 from the corresponding printer application 170. The printer information includes the status information and consumable data described above. This process is executed by notifying an event to the printer application 170 to cause execution of step S600.

In step S1030, the management software 301 displays the management software screen shown in FIG. 9 on the display unit 340.

In step S1035, the management software 301 waits until an event is received. The events may include printer list updates, elapsing a predetermined time period, arrival at a set time, operation of the Pause/Resume button 307, and operation of the Cleaning button 308.

In step S1040, the management software 301 determines whether the printer list has been updated in step S1015. If the list has been updated (step S1040: Yes), the process returns to step S1020. If not (step S1040: No), the process proceeds to step S1045.

In step S1045, the management software 301 determines whether a predetermined time (e.g., 10 seconds) has elapsed since the last execution of step S1050. If the time has elapsed (step S1045: Yes), the process proceeds to step S1050.

In step S1050, the management software 301 updates the status information of all printers 200 with the status information obtained in step S1025. The process then returns to step S1020. By repeating steps S1050 and S1020 to S1030 every predetermined time (e.g., every 10 seconds), the status information on the management software screen is updated to the latest state. This process is executed by notifying an event to the printer application 170 to cause execution of step S600.

On the other hand, if the predetermined time has not elapsed in step S1045 (step S1045: No), the process proceeds to step S1055.

In step S1055, the management software 301 determines whether a predetermined time of day has been reached. If the predetermined time of day has been reached (step S1055: Yes), the process proceeds to step S1060.

In step S1060, the management software 301 outputs an information transmission request to each printer application 170 found in step S1010, requesting transmission of consumable information including consumable data related to the consumption status of consumables in the corresponding printer 200. Specifically, the management software 301 outputs the information transmission request to each printer application 170 corresponding to the printers 200 included in the printer list created in step S1015. The management software 301 obtains the consumable information output from each printer application 170 in response to the information transmission request. As a result, the management software 301 obtains Auditor information for all printers 200 in the printing system 1. The Auditor information may be consumable information including consumable data related to the consumption status of consumables in the printer 200. Step S1060 is an example of processing for outputting request for transmission and processing for obtaining consumable information. This process is executed by notifying an event to the printer application 170 to cause execution of step S500.

In step S1065, the management software 301 evaluates the consumption status of consumables for each printer 200 based on the Auditor information obtained in step S1060. This step S1065 is an example of processing for evaluating status of consumable.

In step S1070, the management software 301 determines whether any action is required regarding the consumable status, based on the evaluation result in step S1065. If it determines that no action is required (step S1070: No), the process returns to step S1020. If it determines that action is required (step S1070: Yes), the process proceeds to step S1075.

In step S1075, the management software 301 executes a corresponding action based on the evaluation result in step S1065. The action may include issuing a warning to the user or automatically ordering consumables. Step S1075 is an example of processing for execute action. The process then returns to step S1020.

Although steps S1060 to S1075 are executed at a predetermined time of day as determined in step S1055, they may be executed at predetermined intervals.

On the other hand, if the predetermined time of day has not been reached in step S1055 (step S1055: No), the process proceeds to step S1080.

In step S1080, the management software 301 determines whether the Pause/Resume button 307 has been operated. If the Pause/Resume button 307 has been operated (step S1080: Yes), the process proceeds to step S1085.

In step S1085, the management software 301 executes a pause or resume process for the target printer 200 according to the operation of the Pause/Resume button 307. The process then returns to step S1020. This process is executed by notifying an event to the printer application 170 to cause execution of step S700.

On the other hand, if the Pause/Resume button 307 has not been operated in step S1080 (step S1080: No), the process proceeds to step S1090.

In step S1090, the management software 301 determines whether the Cleaning button 308 has been operated. If the button 308 has been operated (step S1090: Yes), the process proceeds to step S1095.

In step S1095, the management software 301 executes a toner cleaning process for the target printer 200. This process is executed by notifying an event to the printer application 170 to cause execution of step S800. The process then returns to step S1020.

On the other hand, if the Cleaning button 308 has not been operated in step S1090 (step S1090: No), the process returns to step S1020.

### <Effects of the Embodiment>

The printer application 170 of the present embodiment is executable by the processor 110 of the client PC 100 and is capable of supporting a printer 200 that is communicable with the client PC 100. The client PC 100 is equipped with an operating system that includes the CUPS 160, and the information processing program can be registered as a virtual printer in the CUPS 160. When the printer application 170 is registered as a virtual printer in the CUPS 160, the printer application 170 causes the processor 110 of the client PC 100 to execute processing for outputting capability information, processing for transmitting print data, step S10, and step S20. In the processing for outputting capability information, attributes representing the capabilities of the printer 200 are obtained, and the attributes converted based on the obtained attributes are output to the CUPS 160. In the processing for transmitting print data, print data from the CUPS 160 corresponding to the converted attributes is obtained, and the print data converted based on the obtained print data is transmitted to the printer 200. In step S10, the USTATUS DEVICE ON and INFO STATUS commands for inquiring the status of the printer 200 are output to the printer 200. In step S20, the status information from the printer 200 in response to the USTATUS DEVICE ON and INFO STATUS commands is obtained.

According to the present embodiment, the printer application 170, registered as a virtual printer in the CUPS 160, inquires the status of the printer 200 and obtains the status information. Since the printer application 170 mediates between the CUPS 160 and the printer 200 for both print processing and status monitoring, communication with the printer 200 for printing and communication for status monitoring do not interfere with each other. Thus, the present embodiment enables stable coexistence of print processing and status monitoring.

In particular, in the present embodiment, the status information includes status change data via USTATUS, which can be obtained when the status of the printer 200 changes. According to the present embodiment, since the status change data is obtained only when there is a change in status, the processing load can be reduced compared to constantly obtaining and monitoring status information.

In particular, in the present embodiment, step S20, which is to obtain status information from the printer 200, is repeated at predetermined intervals. According to the present embodiment, the status information can always be updated to the latest information.

In particular, in the present embodiment, the printer application 170 causes the processor 110 to execute step S610, which aggregates the status information obtained in step S20 that is repeated at predetermined intervals. According to the present embodiment, the aggregated results of the status information obtained at predetermined intervals can be transmitted externally or displayed.

In particular, in the present embodiment, the printer application 170 causes the processor 110 to execute step S35 and step S610. In step S35, a status collection command from the management PC 300 communicable with the printer application 170 is obtained. In step S610, the status information obtained in step S20 is output to the management PC 300 in response to the status collection command obtained in step S35. According to the present embodiment, the obtained status information can be transmitted to the management PC 300 upon request, allowing the management PC 300 to perform aggregation, display, and other operations.

In particular, in the present embodiment, the printer application 170 causes the processor 110 to output basic status, which is part of the status information obtained in step S20, to the CUPS 160. Since the CUPS 160 does not recognize the printer 200 actually, it cannot directly obtain the basic status information necessary for control from the printer 200. According to the present embodiment, by outputting the basic status information to the CUPS 160, driverless printing by the CUPS 160 can be executed.

In particular, in the present embodiment, the client PC 100 and the printer 200 are connected via a USB cable. The printer application 170 causes the processor 110 to execute step S940 to obtain access privilege to the backend 180 for communication with the printer 200 via the USB cable. In step S10, the printer application 170 outputs USTATUS DEVICE ON and INFO STATUS to the printer 200 via the backend 180 based on the access privilege obtained in step S940. In step S20, the printer application 170 obtains status information from the printer 200 via the backend 180 based on the access privilege obtained in step S940. According to the present embodiment, since the printer application 170 exclusively holds access privilege to the backend 180 and executes outputting USTATUS DEVICE ON and INFO STATUS and obtaining status information, the status monitor can be stably executed regardless of whether printing is in progress.

### <Effects of the Embodiment>

In this embodiment, the printing system 1 includes a plurality of client PCs 100, a plurality of printers 200, and a management PC 300. Each client PC 100 includes the CUPS 160, which is built into the operating system and enables driverless printing without using vendor-specific drivers, and a printer application 170 registered in the CUPS 160 as a virtual printer corresponding to the connected printer 200. The management software 301 of the management PC 300 executes step S1010 and step S1060. In step S1010, each printer application 170 of the client PCs 100 is searched. In step S1060, based on the search results of step S1010, an information transmission request is output to the printer application 170 found in the search, requesting consumable information including consumable data related to the consumable status of the corresponding printer 200. In step S1060, the consumable information output in response to the information transmission request is obtained from each printer application 170 of the client PCs 100.

According to this embodiment, even when a new printer is connected, i.e., added, to the network, the new printer can be automatically detected by step S1010, and by requesting and obtaining the consumable information from the detected printer 200, the consumable information for multiple printers 200 can be managed collectively. This embodiment allows for easy adaptation even when a new printer 200 is connected to the network, enabling efficient management of consumables for the printers 200.

Moreover, in this embodiment, the management software 301 of the management PC 300 executes step S1015 to create a list of printers 200 corresponding to the detected printer applications 170 based on the search results from step S1010. In step S1060, an information transmission request is sent to the printers 200 listed in step S1015. According to this embodiment, by listing the printers 200 detected in step S1010 and requesting consumable information, it is possible to manage consumables efficiently and without omissions.

In particular, in this embodiment, the management software 301 of the management PC 300 executes step S1015 to update the printer list if there is any addition or removal of printer applications 170 discovered in step S1010 after the list has been created in step S1015. In step S1060, an information transmission request is issued to the printer application 170 corresponding to each printer 200 included in the updated list. According to this embodiment, consumable information can be requested while always keeping the printer list up to date, allowing the system to readily accommodate changes in the number of printers 200 in the printing system 1.

In particular, in this embodiment, the management software 301 of the management PC 300 executes step S1060 at a predetermined time or at predetermined intervals. According to this embodiment, consumable information can be requested and obtained from each printer 200 at predetermined times or intervals. By adjusting timing or frequency, the real-time accuracy of consumable information can be improved.

Furthermore, in this embodiment, the management software 301 of the management PC 300 executes steps S1065 to S1075. In step S1065, the consumption status of consumables is evaluated based on the consumable information obtained in step S1060, and in steps S1070 and S1075, corresponding actions are executed based on the evaluation results. This embodiment enables necessary actions such as issuing warnings to users or automatically ordering consumables based on the consumption status of each printer 200.

In particular, in this embodiment, when the printer application 170 of each client PC 100 is registered in the CUPS 160 as a virtual printer, it executes step S210, step S220, a search access reception process, step S35, and step S230. In step S210, an information collection PJL requesting transmission of consumable data related to the consumable status of the corresponding printer 200 is output to the printer 200. In step S220, the consumable data transmitted from the printer 200 in response to the PJL is obtained. In the processing for receiving search access, the search access from the management PC 300 configured to communicate with the client PCs 100 is received. In step S35, a data collection command including consumable data from the management PC 300 is received. In step S230, the consumable information of the corresponding printer 200 is output to the management PC 300 in response to the data collection command accepted in step S35.

According to this embodiment, even when a new printer is connected to the network, the new printer can be automatically detected by allowing the printer application 170 capable of communication with the new printer to accept search access from the management PC 300. Furthermore, by having each printer application 170 output consumable information for the printers 200 to the management PC 300, collective management of consumable information for multiple printers 200 is enabled. This embodiment allows for easy adaptation and efficient management of consumables for the printers 200 even when a new printer is connected, i.e., added, to the network.

In particular, in this embodiment, the printer application 170 on the client PC 100 executes steps S210 and S220 at a predetermined specific time or at predetermined intervals. According to this embodiment, the printer application 170 can request and obtain consumable data regarding the status of consumables installed in the corresponding printer 200 at each predetermined time or interval. By adjusting the predetermined time or interval to increase frequency for obtaining consumable data, the real-time accuracy of consumable data can be improved.

### <Modifications>

The present invention is not limited to the above-described embodiment and may be modified in various ways without departing from the spirit and technical scope of the invention.

In the above embodiment, the printer application 170 transmits the status information obtained in steps S10 to S25 to the management PC 300 in step S610. In addition to this, the status information may also be displayed on the client PC 100. For example, the printer application 170 may output a status display signal to the browsers 104A, 104B to display the status information obtained in steps S10 to S25, thereby providing the status information to user A or user B. This process executed by the printer application 170 is an example of processing for outputting status display signal. According to this modification, the status information obtained in steps S10 to S25 can be provided to the user of the client PC 100.

The flowcharts shown in FIGS. 2 to 8 and FIGS. 12 to 13 do not limit the invention to the procedures illustrated therein. Steps may be added, deleted, or rearranged without departing from the spirit and technical scope of the invention.

In this embodiment, the search processing uses a function of the CUPS 160 to search the printer 200 to identify the corresponding “information processing program,” which is the printer application 170. Alternatively, the printer application 170 may broadcast using UDP, and the management PC 300 may receive this broadcast. The management software 301 may also broadcast using UDP, and the printer application 170 may respond by returning information.

Furthermore, when the printer application 170 is installed on each client PC 100, the installer may notify the management software 301, which stores the information. The stored information may then be searched in the “search process.”

In the present embodiment, consumable information is returned in response to a request from the management software 301. Alternatively, the management software 301 may always wait for incoming information, and the printer application 170 may actively transmit the information. This allows consumable information to be updated in real time and prevents missed updates due to shutdown of the client PC 100 during update. In this case, the printer application 170 pre-registers the management software 301 as the destination for consumable information. The process of accepting this registration is an example of processing of outputting information request.

Furthermore, the methods described in the above embodiment and modifications may be appropriately combined and used as needed.

Additionally, without providing specific examples, the present invention may undergo various modifications within the scope that does not deviate from its spirit.

### <Hardware Configuration of Client PC, Printer, and Management PC>

An example of the hardware configuration of the client PC 100 and the printer 200 will be described with reference to FIG. 14. The hardware configurations of the first client PC 100A and the second client PC 100B may be the same. Likewise, the hardware configurations of the first printer 200A, second printer 200B, third printer 200C, and fourth printer 200D may be the same.

### <Client PC>

As shown in FIG. 14, the client PC 100 includes a processor 110, a storage device 115, a display unit 140, an operation unit 150, and a communication interface 190. These components are connected to each other via a bus 105, allowing data transmission and reception.

The storage device 115 includes a volatile storage device 120 and a non-volatile storage device 130. The volatile storage device 120 may be DRAM and stores various programs and data to be processed. The non-volatile storage device 130 may be a hard disk drive or a solid-state drive and includes a program storage area 131 and a data storage area 132.

Various programs are stored in the program storage area 131. These programs may include the information processing programs based on the flowcharts shown in FIGS. 2 to 7 and FIG. 12. The data storage area 132 stores data necessary for executing the various programs.

The processor 110 is a data processing device, such as a CPU, and executes the various programs stored in the program storage area 131. The processor 110 performs various processes including data communication with the management PC 300 and the printer 200 connected to the network NT. The processor 110 and the information processing program stored in the program storage area 131 are examples of the first control unit.

The display unit 140 may be a liquid crystal display and can display various types of information. The operation unit 150 may be a mouse or keyboard and accepts user operations. The user can input various instructions to the client PC 100 by operating the operation unit 150.

The communication interface 190 may be a wired or wireless network interface for communicating with other devices and is connected to the network NT.

The storage device 115 is not limited to the configuration described above and may be RAM, ROM, EEPROM, HDD, removable USB memory, buffers included in the processor 110, or combinations thereof.

Note that the storage device 115 may be a computer-readable storage medium. The term “computer-readable storage medium” refers to a non-transitory medium. Examples of non-transitory media may include, in addition to the aforementioned examples, recording media such as CD-ROMs and DVD-ROMs. Furthermore, a non-transitory medium is also a tangible medium. The same applies to the storage device 215 of the printer 200 and the storage device 315 of the management PC 300, which will be described later.

### <Printer>

As shown in FIG. 14, the printer 200 includes a processor 210, a storage device 215, a display unit 240, an operation unit 250, a communication interface 270, and a printing unit 290. These components are connected to each other via a bus 205, allowing data transmission and reception.

The storage device 215 comprises a volatile storage device 220 and a non-volatile storage device 230. The volatile storage device 220 may be DRAM and includes an image data storage area 222 for storing image data to be printed. The non-volatile storage device 230 may be NVRAM or flash memory and includes a program storage area 231 and a data storage area 232. The program storage area 231 stores various programs, including firmware such as printing processing programs. The data storage area 232 stores various data necessary for executing these programs.

The processor 210 is a data processing device, such as a CPU, that executes various programs stored in the program storage area 231.

The display unit 240, such as a liquid crystal display, can display various information. The operation unit 250 is a device that accepts user inputs. Users can input various instructions to the printer 200 by operating the operation unit 250. The communication interface 270 is a wired or wireless network interface for communicating with other devices and is connected to the network NT.

The printing unit 290 prints images on sheets conveyed by a transport mechanism. The printing unit 290 prints images on sheets based on print data transmitted from the client PC 100 or based on print jobs generated autonomously based on operations from the operation unit 250.

### <Management PC>

As shown in FIG. 15, the management PC 300 includes a processor 310, a storage device 315, a display unit 340, an operation unit 350, and a communication interface 390. These components are connected to each other via a bus 305, allowing data transmission and reception.

The storage device 315 comprises a volatile storage device 320 and a non-volatile storage device 330. The volatile storage device 320 may be DRAM and stores various programs and data to be processed. The non-volatile storage device 330 may be a hard disk drive or a solid-state drive and includes a program storage area 331 and a data storage area 332.

Various programs are stored in the program storage area 331. These programs include information processing programs based on the flowchart shown in FIG. 13. The data storage area 332 stores data necessary for executing the various programs.

The processor 310 is a data processing device, such as a CPU, and executes the various programs stored in the program storage area 331. The processor 310 performs various processes including data communication with the client PCs 100 connected to the network NT. The processor 310 and the information processing program stored in the program storage area 331 are examples of a control unit and a second control unit.

The display unit 340, such as a liquid crystal display, can display various information. The operation unit 350, such as a mouse or keyboard, accepts user inputs. Users can input various instructions to the management PC 300 by operating the operation unit 350.

The communication interface 390 is a wired or wireless network interface for communicating with other devices and is connected to the network NT.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

What is claimed is:

1. A non-transitory computer-readable recording medium that stores an information processing program executable by a processing unit of an information processing device that communicates with a corresponding printing device, wherein the information processing device includes an operating system with an OS-standard printing software for driverless printing, the information processing program, when registered as a virtual printing device with the OS-standard printing software and executed, causing the information processing device to perform:
obtaining first print data from the OS-standard printing software;
transmitting second print data based on the first print data to a printing device;
outputting an inquiry signal to the printing device to query status of the printing device; and
obtaining status information from the printing device in response to the output of the inquiry signal.

2. A non-transitory computer-readable recording medium that stores the information processing program of claim 1, wherein the status information includes status change data that is obtained when status of the printing device changes.

3. A non-transitory computer-readable recording medium that stores the information processing program of claim 1, wherein the outputting the inquiry signal and the obtaining the status information are repeated at predetermined intervals.

4. A non-transitory computer-readable recording medium that stores the information processing program of claim 3, wherein the information processing program, when executed, further causes the information processing apparatus to perform:
aggregating the status information obtained during the outputting the inquiry signal and the obtaining the status information are repeated.

5. A non-transitory computer-readable recording medium that stores the information processing program of claim 1, wherein the information processing program, when executed, further causes the information processing apparatus to perform:
obtaining an information collection signal from an external device communicably connected to the information processing device; and
outputting the obtained status information to the external device in response to the information collection signal.

6. A non-transitory computer-readable recording medium that stores the information processing program of claim 1, wherein the information processing program, when executed, further causes the information processing apparatus to perform:
outputting a status display signal for displaying the obtained status information.

7. A non-transitory computer-readable recording medium that stores the information processing program of claim 6, wherein the information processing program, when executed, further causes the information processing apparatus to perform:
outputting basic status information, which is part of the obtained status information, to the OS-standard printing software.

8. A non-transitory computer-readable recording medium that stores the information processing program of claim 1,
wherein the information processing device and the printing device are connected via a USB cable, and
wherein the information processing program, when executed, further causes the information processing apparatus to perform:
obtaining access privilege for communication with a backend through the USB cable,
wherein the outputting the inquiry signal includes outputting the inquiry signal, through the backend, to the printing device based on the obtained access privilege, and
wherein the obtaining the status information includes obtaining the status information, through the backend, from the printing device based on the obtained access privilege.

9. In an information processing system comprising a first information processing device, a printing device, and a second information processing device, the first information processing device including an OS-standard printing software for executing driverless printing, and a control unit that has an information processing program registered with the OS-standard printing software as a virtual printer corresponding to the printing device,
a non-transitory computer-readable recording medium that stores an information processing program executable by a processing unit of the second information processing device, the information processing program, when executed, causing the second information processing device to perform:
searching the information processing program of the first information processing device;
outputting to the searched information processing program a request for transmission of consumable information including consumption data regarding consumables of the printing device; and
obtaining the consumable information output from the first information processing device, in response to the request.

10. A non-transitory computer-readable recording medium that stores the information processing program of claim 9, wherein the information processing program, when executed, further causes the second information processing device to perform:
creating a list of the printing device corresponding to the searched information processing programs,
wherein, in the outputting the request for transmission, the request for transmission is output to the information processing program corresponding to the printing device included in the created list.

11. A non-transitory computer-readable recording medium that stores the information processing program of claim 10, wherein the information processing program, when executed, further causes the second information processing device to perform:
updating the list based on the number of the searched information processing program, the number being changed after creating the list,
wherein, in the outputting the request for transmission, the request for transmission is output to the information processing program corresponding to the printing device included in the updated list.

12. A non-transitory computer-readable recording medium that stores the information processing program of claim 9, wherein the outputting the request for transmission and the obtaining the consumable information are executed at a predetermined time or at predetermined intervals.

13. A non-transitory computer-readable recording medium that stores the information processing program of claim 9, wherein the information processing program, when executed, further causes the second information processing device to perform:
evaluating status of the consumables based on the obtained consumable information; and
executing an action based on the evaluation.

14. A non-transitory computer-readable recording medium that stores an information processing program executable by a processing unit of a first information processing device that communicates with a corresponding printing device, wherein the first information processing device includes an operating system and an OS-standard printing software, the information processing program, when registered as a virtual printing device with the OS-standard printing software and executed, causing the first information processing device to perform:
outputting to the printing device a data transmission request for consumable data including consumption data regarding consumables of the printing device;
obtaining the consumable data transmitted from the printing device in response to the data transmission request;
receiving a search access from a second information processing device communicable with the first information processing device;
receiving a request for transmission of consumable information from the second information processing device after receiving the search access, the consumable information including the consumable data; and
outputting the consumable information of the printing device to the second information processing device in response to the received request for transmission.

15. A non-transitory computer-readable recording medium that stores the information processing program of claim 14, wherein the outputting the request for transmission and the obtaining the consumable information are executed at a predetermined time or at predetermined intervals.

16. An information processing system comprising:
a first information processing devices having an OS-standard printing software for executing driverless printing and an information processing program registered with the OS-standard printing software as a virtual printer corresponding to a printing device; and
a second information processing device communicable with the first information processing device,
wherein
the first information processing device is configured to execute:
outputting to the printing device a data transmission request for consumable data including consumption data regarding consumables of the printing device;
obtaining the consumable data transmitted from the printing device in response to the data transmission request; and
receiving a search access from the second information processing device,
the second information processing device is configured to execute:
searching the information processing program of the first information processing device; and
outputting to the searched information processing program a request for transmission of consumable information including the consumption data,
the first information processing device is configured to further execute:
receiving the output request for transmission; and
outputting the consumable information of the printing device to the second information processing device in response to the received request for transmission, and
the second information processing device is configured to further execute:
obtaining the consumable information output from the first information processing device.
